(19) United States
(12) Patent Application Publication
(10) Pub. No.: US 2026/0311939 A1
(43) Pub. Date: Oct. 8, 2026

(54) SWITCH POLE FOR ELECTRICAL SYSTEMS

(71) Applicant: ABB S.p.A., Milano (IT)

(72) Inventors: Pierantonio Arrighetti, Bossico (IT); Pierre Corfdir, Dättwil (CH)

(21) Appl. No.: 19/465,212

(22) Filed: Jan. 30, 2026

(30) Foreign Application Priority Data
Apr. 4, 2025 (EP) 25168656.4

(51) Int. Cl. H01H 3/02; H01H 1/22; H01H 1/64; H01H 9/30; H01H 9/32

(52) U.S. Cl. CPC H01H 3/0206; H01H 1/226; H01H 1/64; H01H 9/32; H01H 2001/228; H01H 2009/305

(57) ABSTRACT

A switch pole for a low voltage switching device includes an insulating casing that defines an internal space with a contact region and an arc extinguishing region. The switch pole further includes a first pole terminal and a second pole terminal, each connectable to corresponding line conductors of an electric line. A fixed contact assembly and a movable contact assembly are arranged in the contact region and include fixed contacts and movable contacts that can be selectively coupled or uncoupled. The movable contact assembly includes an insulating baffle that protrudes toward the fixed contact assembly and is at least partially slidably received in a recess formed in the insulating casing. The insulating baffle is arranged between first and second fixed contacts of the fixed contact assembly and between first and second movable contacts of the movable contact assembly.

### CROSS-REFERENCE TO RELATED APPLICATIONS

This application claims priority to European Patent application No. 25168656.4, filed on Apr. 4, 2025, and titled “SWITCH POLE FOR ELECTRICAL SYSTEMS”, the entire contents of which are hereby incorporated by reference.

### TECHNICAL FIELD

The present disclosure relates to a switch pole for a switching device suitable for installation in low-voltage electrical systems. The disclosure likewise relates to a switching device comprising one or more of said switch poles.

### BACKGROUND

Low voltage switching devices, such as for example circuit breakers, disconnectors, contactors, or the like, comprise one or more switch poles, each including electric contacts that can be coupled to and uncoupled from one another.

As is known, during an opening maneuver of a switching device, electric arcs may arise between the electric contacts of the switch poles under separation, particularly under stress conditions (for example in presence of overload currents or short-circuit currents).

In order to break currents circulating along the switch poles, such arcing phenomena have to be extinguished as quickly as possible. To this aim, a switching device generally comprises, for each switch pole, an arc chamber including a number of arc-breaking elements positioned near the electric contacts and designed to split possible electric arcs arising between the electric contacts. Unfortunately, the arc-quenching action exerted by the arc-breaking elements is not always uniform and efficient, which may lead to a decay of the arc-quenching performances and the arising of arc-restrike phenomena.

Moreover, it has been seen that, during an opening maneuver of a switching device, electric arcs sometime tend to strike towards undesired areas of the switch pole. Obviously, the components affected by these phenomena may be subject to serious damage since they are not generally designed to bear high electric and thermal stresses.

The above-mentioned problems are even made more critical by the circumstance that, in modern electric power distribution grids, switching devices are often brought to operate to relatively high operating voltages (for example up to 2.0-2.5 kV either AC or DC). Electric arcs with a huge energy content may therefore arise between the electric contacts under separation during the opening maneuvers of a switching device.

### BRIEF DESCRIPTION

The main purpose of the present disclosure is to provide a switch pole for low voltage switching devices, which allows overcoming or mitigating the above-mentioned shortcomings.

In particular, the present disclosure is aimed at providing a switch pole, in which electric arcs arising between the electric contacts under separation during the opening maneuvers of the switching device are efficiently confined in the arc-extinguishing region of the switch pole.

A further object of the present disclosure is to provide a switch pole, in which arcing phenomena towards undesired parts of the switch pole are prevented or remarkably reduced.

A still further object of the present disclosure is to provide a switch pole reliable in operation and relatively easy and cheap to manufacture at industrial level.

The above aims and purposes, as well as other purposes that will emerge clearly from the following description and attached drawings, are provided, according to the disclosure, by a switch pole for a low voltage switching device.

The switch pole, according to the present disclosure, comprises an insulating casing defining an internal space of the switch pole, a first pole terminal and a second pole terminal couplable with corresponding line conductors of an electric line.

The switch pole, according to the present disclosure, comprises a fixed contact assembly including a plurality of fixed electric contacts electrically connected to the first pole terminal. The fixed electric contacts include one or more first fixed contacts, and one or more second fixed contacts spaced apart and electrically insulated from the first fixed contacts.

The switch pole, according to the present disclosure, comprises a movable contact assembly including a plurality of movable electric contacts electrically connected to the second pole terminal. The movable electric contacts include one or more first movable contacts and one or more second movable contacts.

The movable contact assembly is reversibly movable around a rotation axis, so that the first movable contacts can be coupled to or decoupled from the first fixed contacts and the second movable contacts can be coupled to or decoupled from the second fixed contacts, when the movable contact assembly moves about the rotation axis, during a maneuver of the switch pole.

In some embodiments, the movable contact assembly comprises a supporting structure of the movable contacts of the movable contact assembly.

In some embodiments, the movable contact assembly comprises an insulating cover at least partially covering one or more conductive portions of the movable contact assembly. The insulating cover is mounted on the supporting structure in such a way to move together with the supporting structure, when the movable contact assembly moves about its rotation axis, during a maneuver of the switch pole.

According to the present disclosure, the movable contact assembly comprises an insulating baffle protruding towards the fixed contact assembly and slidingly inserted, at least partially, in a receiving recess defined by the insulating casing.

The insulating baffle is interposed between the one or more first fixed contacts and the one or more second fixed contacts of the fixed contact assembly and is interposed between the one or more first movable contacts and the one or more second movable contacts of the movable contact assembly.

In some embodiments, the insulating baffle is fixed to the supporting structure of the movable contact assembly in such a way to move together with the supporting structure, when the movable contact assembly moves about its rotation axis, during a maneuver of the switch pole.

In some embodiments, the insulating baffle is positioned at a first spacing region between the one or more first movable contacts and the one or more second movable contacts of the movable contact assembly.

In some embodiments, the receiving recess has an aperture for the passage of insulating baffle, which is positioned at a second spacing region between the one or more first fixed contacts and the one or more second fixed contacts of the fixed contact assembly.

In some embodiments, the insulating baffle has a free end in an opposite position relative to the movable contacts of the movable contact assembly. The free end of the insulating baffle is inserted in the receiving recess and slidingly moves along this latter, when the movable contact assembly moves about the rotation axis, during a maneuver of the switch pole.

According to some embodiments of the present disclosure, the insulating baffle has a piston portion slidingly moving along the receiving recess, when the movable contact assembly moves about the rotation axis, during a maneuver of the switch pole. Such a piston portion of the insulating baffle causes a flux of pressurized air to blow towards the one or more second fixed contacts of the fixed contact assembly and the one or more second movable contacts of the movable contact assembly, during an opening maneuver of the switch pole.

In some embodiments, the piston portion is formed by the L-shaped free end of the insulating baffle.

According to some embodiments of the present disclosure, the insulating cover of the movable contact assembly is fixed to the supporting structure of the movable contact assembly.

In some embodiments, the above-mentioned insulating baffle is sometimes formed by a portion of the insulating cover.

According to other embodiments of the present disclosure, the insulating cover of the movable contact assembly is hinged on the supporting structure and can reversibly move relative to the supporting structure, when the movable contact assembly moves about its rotation axis, during a maneuver of the switch pole.

In some embodiments, the insulating cover can move reversibly between a first shield position, at which the insulating cover has no portions interposed between the electric contacts of the switch pole, and a second shield position, at which the insulating cover has a shield portion interposed between the one or more first fixed contacts of the fixed contact assembly and the one or more first movable contacts of the movable contact assembly.

In some embodiments, the insulating cover moves from the above-mentioned first shield position to the above-mentioned second shield position during an opening maneuver of the switch pole.

In some embodiments, when it is in the second shield position, the shield portion of the insulating cover covers the one or more first movable contacts of the movable contact assembly.

In a further aspect, the present disclosure relates to a low voltage switching device, sometimes a circuit breaker, including at least a switch pole, according to the disclosure, as described above.

### BRIEF DESCRIPTION OF DRAWINGS

Further features and advantages of the present disclosure will be evident from the description of some embodiments of a switch pole, according to the disclosure, shown by way of examples in the accompanying drawings, wherein:

FIG. 1 is a schematic view of a switching apparatus including the switch pole, according to the present disclosure;

FIGS. 2-6 schematically show the structure and operation of the switch pole, according to an embodiment of the present disclosure;

FIGS. 7-10 schematically show the structure and operation of the switch pole, according to another embodiment of the present disclosure;

FIGS. 11, 11A-11B, and 12-14 schematically show the structure and operation of the switch pole, according to a further embodiment of the present disclosure; and

FIGS. 15-17 schematically show the structure and operation of the switch pole, according to a further embodiment of the present disclosure.

### DETAILED DESCRIPTION

With reference to the attached figures, the present disclosure relates to a switch pole 1 for a low voltage switching device, for example a circuit breaker, a disconnector, a contactor, or the like.

The switching device is particularly adapted for use in AC low-voltage electrical systems, and it will be described with particular reference to these applications. However, in principle, it may be used also in electric systems of different type, for example in DC low-voltage electrical systems.

For the purposes of the present disclosure, the term “low voltage” typically relates to operating voltages up to 2.0 kV AC and 2.5 kV DC, as widely known.

The switching device comprises one or more switch poles 1, according to the present disclosure.

The number of switch poles may vary, according to the needs.

In some embodiments, the switching device may be of the three-phase type, and it comprises three switch poles. However, according to other embodiments of the present disclosure, the switching device may include a different number of switch poles depending on the number of electric phases of the electric circuit, in which it has to be installed.

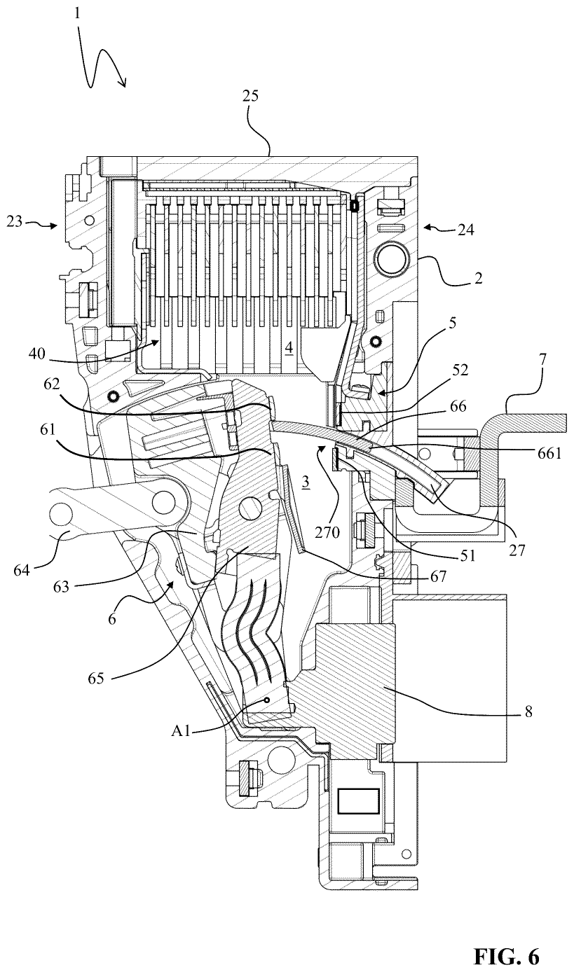

According to the present disclosure, a switch pole 1, according to the disclosure, comprises an insulating casing 2 defining an internal volume including a contact region 3 and an arc extinguishing region 4 (FIGS. 6, 10, 14, 17).

In general terms, the contact region 3 is a portion of internal volume of the switch pole where the contact assemblies of the switch pole are arranged and operate. On the other hand, the arc-extinguishing region 4 is a portion of internal volume of the switch pole where there are arranged arc-quenching means designed to extinguish possible electric arcs arising between the electric contacts of the switch pole, during the opening maneuvers.

The contact region 3 and the arc extinguishing region 4 are adjacent and in fluid-dynamic communication with one another.

In some embodiments, the arc extinguishing region 4 is positioned at an upper level with respect to the contact region 3, namely, in proximal position relative to a top side of this latter.

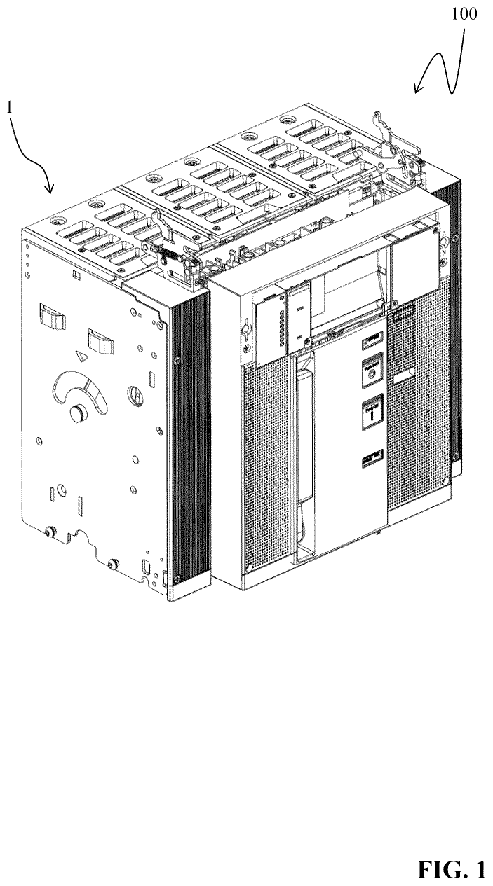

For the sake of clarity, it is specified that relative terms used in this disclosure, for example “front,” “rear,” “lateral”, “upper”, “lower”, “top” and “bottom” relate to the switch pole 1 in its normal installation conditions, namely in a “vertical” installation mode (FIG. 1).

The insulating casing 2 of the switch pole is shaped as a contoured box with opposite front and rear walls 23, 24, opposite lateral walls 21, 22 and opposite top and bottom walls 25, 26.

In some embodiments, the insulating casing 2 is formed by first and second half shields joined to each other. In some embodiments, the top wall 25 is provided with a number of through openings to allow the exit of hot gases from the internal volume of the switch pole, in particular from the arc extinguishing region. The insulating casing 2 is made of an electrically insulating material, for example a thermosetting or thermoplastic material.

According to the present disclosure, the switch pole 1 comprises a first pole terminal 7 and a second pole terminal 8 couplable with corresponding line conductors of an electric line.

In operation, the pole terminals 7, 8 are electrically coupled (in a known manner) with corresponding line conductors of an electric line. Such line conductors may be, in turn, electrically connected to an electric power source (for example an electric power feeding or generation system or a section of electric grid) and to an electric load (for example an electric system or apparatus or a section of electric grid) , respectively.

For the sake of clarity, it is specified that the terms “coupled,” “decoupled” or “couplable” used in this disclosure relate to both an electrical and mechanical coupling/decoupling of various parts unless otherwise specified or self-evident from the description or figures.

In some embodiments, the pole terminals 7, 8 are positioned at the rear wall 24 of the insulating casing of the switch pole.

According to the present disclosure, a switch pole 1 comprises a fixed contact assembly 5 and a movable contact assembly 6 arranged in the contact region 3.

The fixed contact assembly 5 comprises fixed electric contacts 51, 52 electrically connected to the first pole terminal 7.

More particularly, the fixed contact assembly 5 includes one or more first fixed contacts 51 and one or more second fixed contacts 52, which are spaced apart from the fixed contacts 51 and electrically insulated from these latter.

The first and second fixed contacts 51, 52 are therefore electrically connected in parallel to the first pole terminal 7 but they are mutually spaced and electrically insulated.

In some embodiments, the first and second fixed contacts 51, 52 are positioned at the rear wall 24 of the insulating casing of the switch pole.

In some embodiments, the first and second fixed contacts 51, 52 are arranged respectively in distal position and in proximal position relative to the arc-extinguishing region 4 of the switch pole.

The first fixed contacts 51 may be formed by a pair of conductive tips arranged on a first conductive base directly coupled to the first pole terminal 7. Similarly, the second fixed contacts 52 may be formed by a pair of conductive tips arranged on a second conductive base electrically connected to the first pole terminal 7 through other conductive components of the switch pole.

In general, the pole terminals 7, 8 and the fixed contact assembly 5 may be realized according to solutions of known type. In the following, this component of the switch pole will be described only in relation to the aspects of interest of the present disclosure, for the sake of brevity.

The movable contact assembly 6 comprises movable electric contacts 61, 62 electrically connected to the second pole terminal 8. More particularly, the movable contact assembly 6 includes one or more first movable contacts 61 and one or more second movable contacts 62.

The first movable contacts 61 can be coupled to or decoupled from the first fixed contacts 51 while the second movable contacts 62 can be coupled to or decoupled from the second fixed contacts 52.

The movable contact assembly 6 is reversibly movable around a rotation axis A1, which is sometimes perpendicular to the lateral walls 22 of the insulating casing of the switch pole.

The movable contact assembly 6 can move, about the rotation axis A1, between a first position corresponding to a closed state of the switch pole, in which electric currents are allowed to flow between the pole terminals 7, 8 of the switch pole, and second position corresponding to an open state of the switch pole, in which electric currents flowing along the switch pole are interrupted.

The movable contact assembly 6 moves between the above-mentioned first and second positions by rotating about the rotation axis A1 according to opposite rotation directions.

A transition of the movable contact assembly 6 from the first position to the second position constitutes an opening maneuver of the switch pole, whereas an opposite transition of the movable contact assembly 6 from the second position to the first position constitutes a closing maneuver of the switch pole.

In some embodiments, the first and second movable contacts 61, 62 are arranged in distal position and in proximal position relative to the arc-extinguishing region 4 of the switch pole, respectively.

In some embodiments, the movable electric contacts 61, 62 are electrically connected to one another and electrically connected in parallel to the second pole terminal 8.

In some embodiments, the movable contact assembly 6 comprises a conductive head 65, on which the movable contacts 61, 62 are mounted.

The conductive head 65 is electrically connected to the second pole terminal 8, for example by means of suitable flexible conductors.

The first and second movable contacts 61, 62 may be formed by first and second pairs of conductive fingers, respectively, which protrude from the conductive head 65.

In some embodiments, the movable contact assembly 6 comprises a supporting structure 63 for the movable contacts 61, 62. Such a supporting structure can conveniently rotate about a rotation axis A1 and it comprises a connecting element 64, which protrudes outside the insulating casing of the switch pole (sometimes from a suitable window of the front wall 23 thereof) for connection with a driving mechanism (not shown).

In some embodiments, the conductive head 65, which supports and connect electrically the movable contacts 61, 62 of the switch pole, is mounted on the supporting structure 63 in such a way to move together with said supporting structure about the rotation axis A1, during a maneuver of the switch pole.

In some embodiments, the conductive head 65 is hinged to the supporting structure 63 about a suitable hinging axis, which is conveniently parallel to the rotation axis A1 of the movable contact assembly. The conductive head 65 thus rotates together with the supporting structure 63 about the rotation axis A1 and it can slightly tilt relative to said supporting structure, when this latter moves. Namely, when the supporting structure 63 rotates according to a given rotation direction, the conductive head 65 can tilt with an opposite rotation movement relative to the supporting structure.

In some embodiments, the movable contact assembly 6 comprises an insulated cover 67 covering, at least partially, one or more conductive parts, for example the conductive head 65. The insulating cover 67 is mounted on the supporting structure 63 in such a way to move together with this latter when the movable contact assembly moves about the rotation axis A1, during a maneuver of the switch pole.

As mentioned above, in general terms, the switch pole 1 can take in operation a closed state and an open state and can carry out an opening maneuver to switch from a closed state to an open state and a closing maneuver to switch from an open state to a closed state.

In the switch pole 1, the fixed and movable contact assemblies 5, 6 are arranged so that a pole current flows along the one or more first fixed contacts 51 and the one or more first movable contacts 61 when the switch pole is in a closed state. The electric contacts 51, 61 thus form the so-called “main contacts” of the switch pole.

Additionally, the fixed and movable contact assemblies 5, 6 are arranged so that electric arcs normally develop between the electric contacts 52, 62 under separation during an opening maneuver of the switch pole. The electric contacts 52, 62 thus form the so-called “arc contacts” of the switch pole.

In the embodiments shown in the cited figures, the first and second movable contacts 61, 62 decouple from the first and second fixed contacts 51, 52, according to a specific opening sequence (described in the following), during an opening maneuver of the switch pole.

When the movable contact assembly 6 is the above-mentioned first position (closed state of the switch pole), the first movable contacts 61 are coupled to the first fixed contacts 51 while the second movable contacts 62 are decoupled from the second fixed contacts 52.

In this situation, a pole current can flow along the switch pole between the pole terminals 7, 8. The pole current passes entirely through the first movable contacts 61 and the first fixed contacts 51. No electric arcs arise between the movable contact assembly 6 and the fixed contact assembly 5 as the pole terminals 7, 8 are short-circuited.

During an opening maneuver of the switch pole, upon an initial movement according to a suitable rotation direction about the rotation axis, the movable contact assembly 6 moves from the first position to a first intermediate position, in which the first movable contacts 61 are coupled to the first fixed contacts 51 and the second movable contacts 62 are coupled to the second fixed contacts 52.

In this situation, a pole current can still flow between the pole terminals 7, 8. The pole current is however split between a first current passing through the first movable contacts 61 and the first fixed contacts 51 and a second current passing through the second movable contacts 62 and the second fixed contacts 52. The magnitude of the first and second currents depends on equivalent resistance of the respective conductive paths.

No electric arcs arise between the movable contact assembly 6 and the fixed contact assembly 5 as the pole terminals 7, 8 are still short-circuited.

Upon a further movement according to the rotation direction, the movable contact assembly 6 moves from the above-mentioned first intermediate position to a second intermediate position, in which the first movable contacts 61 are decoupled from the first fixed contacts 51 and the second movable contacts 62 are coupled to the second fixed contacts 52.

In this situation, a pole current can still flow along the switch pole between the pole terminals 7, 8 as these latter are still short-circuited. The pole current passes entirely through the second movable contacts 62 and the second fixed contacts 52. No currents flow along the first movable contacts 61 and the first fixed contacts 51 as these latter are decoupled.

No electric arcs arise between the movable contact assembly 6 and the fixed contact assembly 5 as the pole terminals 7, 8 are still short-circuited.

Upon yet a further movement according to the rotation direction, the movable contact assembly 6 moves from the second intermediate position to the above-mentioned second position. In this phase of the opening maneuver, also the second movable contacts 62 decouple from the second fixed contacts 52 (the first movable contacts 61 are decoupled from the first fixed contacts 51). In this situation, as the movable electric contacts 61, 62 are now separated from the corresponding fixed electric contacts 51, 52, a difference of voltage potential is established between the first and second pole terminals 7, 8. At any time, the second pole terminal (and the movable contacts 61, 62) may have a positive voltage polarity while the first pole terminal 7 (and the fixed contacts 51, 52) may have a negative voltage polarity, or vice-versa). Since the dielectric distance between the movable contacts 61, 62 and the fixed contacts 51, 52 is relatively short, electric arcs may develop between the movable contact assembly 6 and the fixed contact assembly 5, particularly between the second fixed contacts 52 and the second movable contacts 62 under separation.

According to different embodiments of the present disclosure, the first and second movable contacts 61, 62 may decouple from the first and second fixed contacts 51, 52, according to a different opening sequence, during an opening maneuver of the switch pole.

In the embodiments shown in the cited figures, the first and second movable contacts 61, 62 couple to the first and second fixed contacts 51, 52, according to a specific closing sequence, during a closing maneuver of the switch pole. The closing sequence of the electric contacts is basically the opposite compared to the opening sequence described above.

According to different embodiments of the present disclosure, however, the first and second movable contacts 61, 62 may couple to the first and second fixed contacts 51, 52, according to a different closing sequence, during a closing maneuver of the switch pole.

In some embodiments, the switch pole 1 comprises an arc chamber 40 positioned in the arc extinguishing region 4, conveniently above the contact region 3 and in fluid-communication with this latter.

The arc chamber 40 comprises a plurality of arc-breaking elements designed to extinguish possible electric arcs arising between the electric contacts of the switch pole when these latter separate during an opening maneuver. The arc-breaking elements may be arc-breaking plates arranged in parallel, sometimes along reference planes parallel to the front and rear walls 23, 24 and perpendicular to the lateral walls 22 of the insulating casing 2. The arc-breaking plates are sometimes arranged at subsequent positions between the front and rear walls 23, 24, at increasing distances from the fixed contact assembly 5. In some embodiments, the arc-breaking plates may be formed by contoured metallic or ceramic plates, which can have different dimensions and shapes according to solutions of known type.

An essential aspect of the present disclosure consists in that the movable contact assembly 6 comprises an insulating baffle 66, which is arranged in such a way to segregate the main contacts 51, 61 of the switch pole from the arc contacts 52, 62 of the switch pole.

The insulating baffle 66 protrudes towards the fixed contact assembly 5 and is slidingly inserted, at least partially, in a receiving recess 27 of the insulating casing 2.

As it is possible to notice from the cited figures, the insulating baffle 66 is always interposed between the one or more first fixed contacts 51 and the one or more second fixed contacts 52 of the fixed contact assembly and to be interposed between the one or more first movable contacts 61 and the one or more second movable contacts 62 of the movable contact assembly.

The insulating baffle 66 can thus prevent the diffusion of hot gases towards the lower regions of the internal volume of the switch pole, thereby greatly favoring their flow towards the arc-extinguishing region 4. This helps to confine hot gases in the arc-extinguishing region 4 and makes the quenching performance of the arc chamber 40 more effective.

As the insulating baffle 66 substantially segregates the main contacts 51, 61 of the switch pole from the arc contacts 52, 62 of the switch pole, the probability of re-striking phenomena involving the main contacts 51, 61 of the switch pole is remarkably decreased, which greatly helps to preserve these electric contacts from an excessive erosion, thus prolonging their operating life.

The insulating baffle 66 additionally effectively prevents electric arcs from “jumping” towards conductive components of the switch pole outside the arc-extinguishing region 4.

In some embodiments, the insulating baffle 66 is made of an electrically insulating material, for example a thermosetting or thermoplastic material.

In some embodiments, the insulating baffle 66 is fixed to the supporting structure 63 in such a way to move together with this latter about the rotation axis A1, during a maneuver of the switch pole.

In some embodiments, the insulating baffle 66 is positioned and protrudes towards the fixed contact assembly 5 at a first spacing region between the one or more first movable contacts 61 and the one or more second movable contacts 62 of the movable contact assembly.

In some embodiments, the insulating baffle 66 has a free end 661 in an opposite position relative to the movable contacts 61, 62 of the movable contact assembly. The free end 661 is inserted in the receiving recess 27 and slidingly moves along this latter, when the movable contact assembly moves about the rotation axis A1, during a maneuver of said switch pole.

In some embodiments, the receiving recess 27 is defined at the rear wall 24 of the insulating casing, at a region where the fixed contact assembly 5 is arranged.

In some embodiments, the receiving recess 27 has an aperture 270 for the passage of the insulating baffle 66, which is positioned at a second spacing region positioned between the one or more first fixed contacts 51 and the one or more second fixed contacts 52 of the fixed contact assembly.

In some embodiments, at the region where the fixed contact assembly 5 is arranged, the rear wall 24 of the insulating casing has a pass-through hole and a hollow protrusion 271 defining the receiving recess 27, in which insulating baffle 66 is slidingly inserted. This solution allows reducing the lateral size of the switch pole despite of the presence of the insulating baffle.

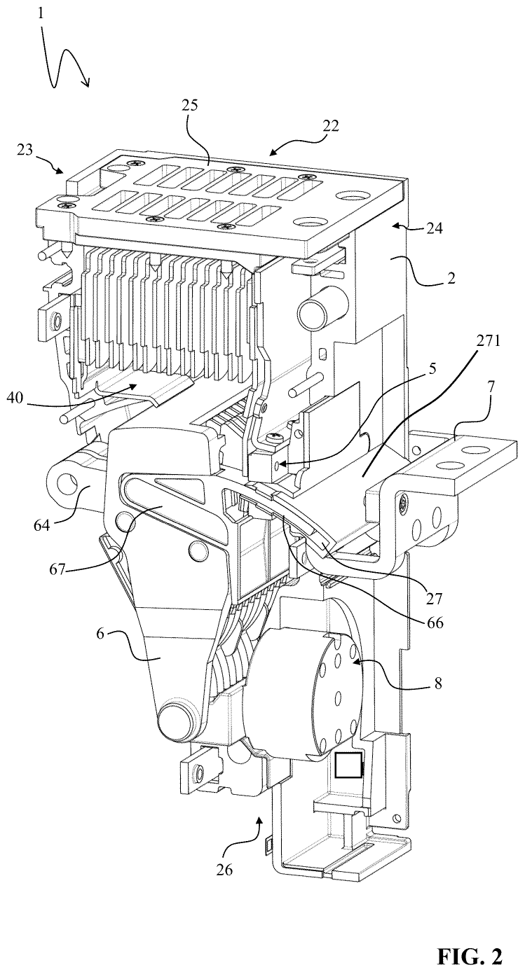

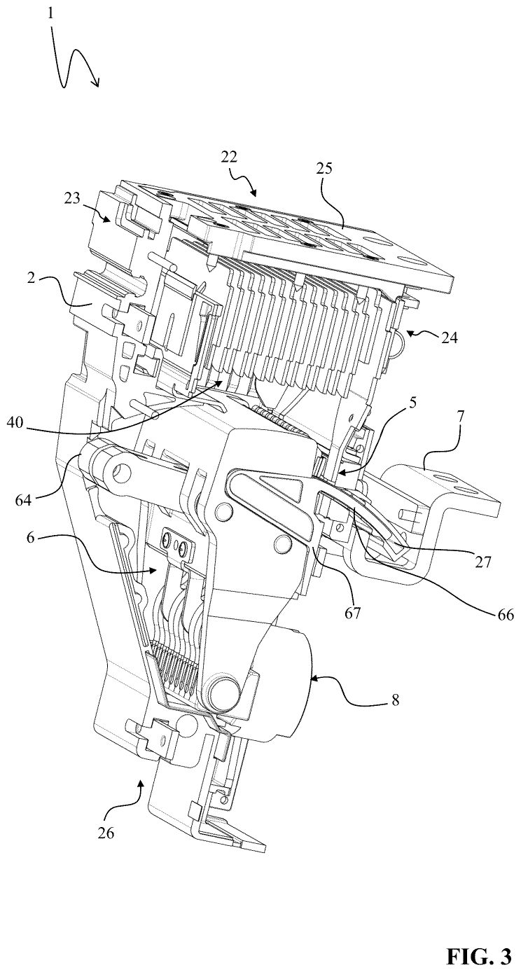

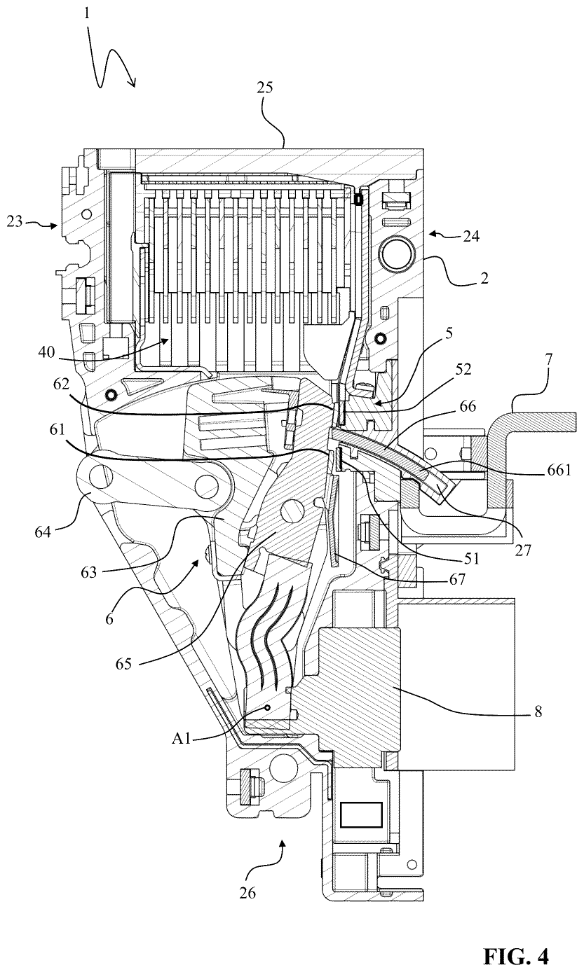

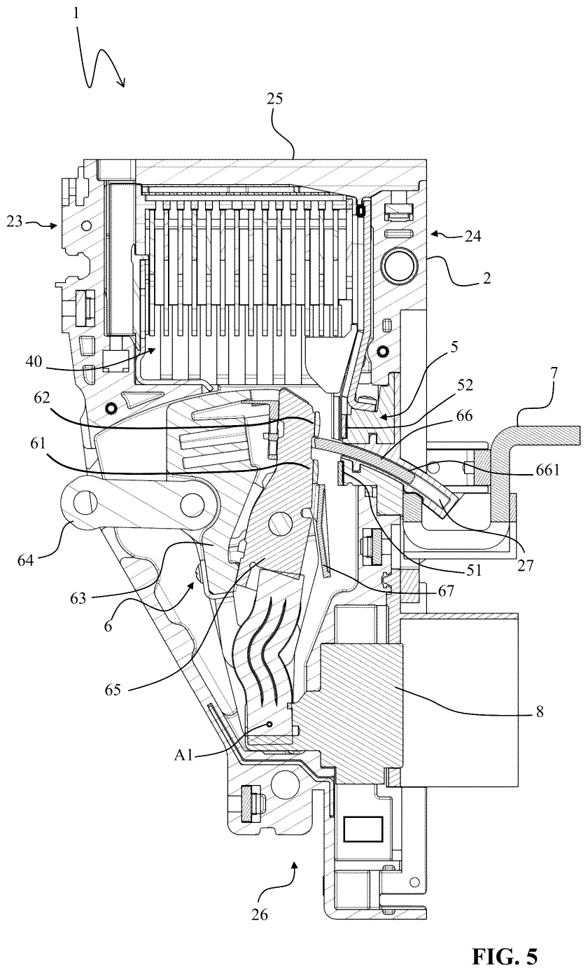

FIGS. 2-6 show the switch pole, according to an embodiment of the present disclosure. In FIGS. 4-6, the movable contact assembly 6 is shown in different operating positions during a maneuver of the switch pole.

The insulating baffle 66 has a rectilinear free end 661 inserted in the receiving recess 27 and slidingly moving along this latter. The receiving recess 27 is formed as a blind recess.

The insulating baffle 66 and the receiving recess 27 have curved (namely arc-shaped) complementary profiles along a reference plane perpendicular to the rotation axis A1.

According to other embodiments of the present disclosure, the insulating baffle 66 and the receiving recess 27 may be arranged differently from the solution shown in FIGS. 2-6.

For example, the insulating baffle 66 and the receiving recess 27 may have a differently shaped profile. As a further example, the receiving recess 27 may have additional apertures configured to put the receiving recess in fluid-dynamic communication with the internal volume of the switch pole and/or the outer environment.

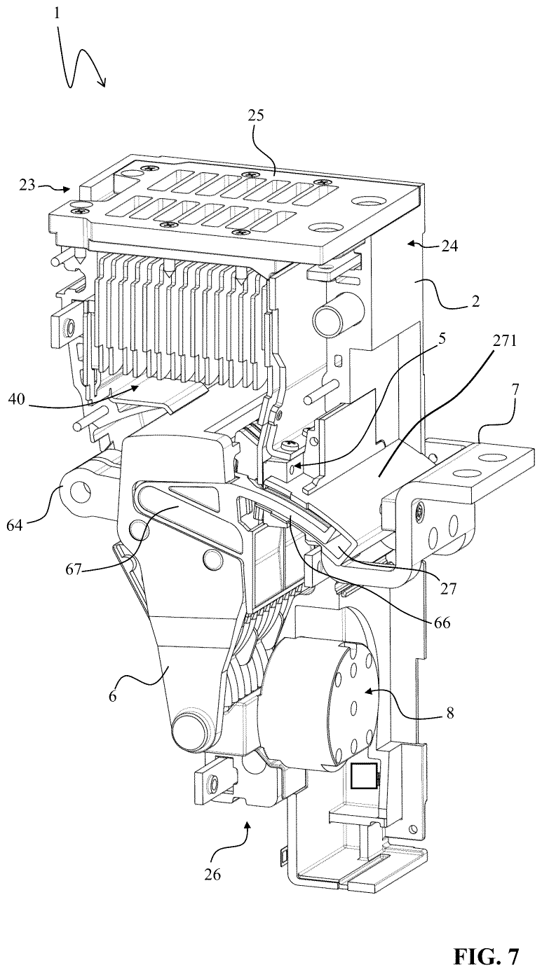

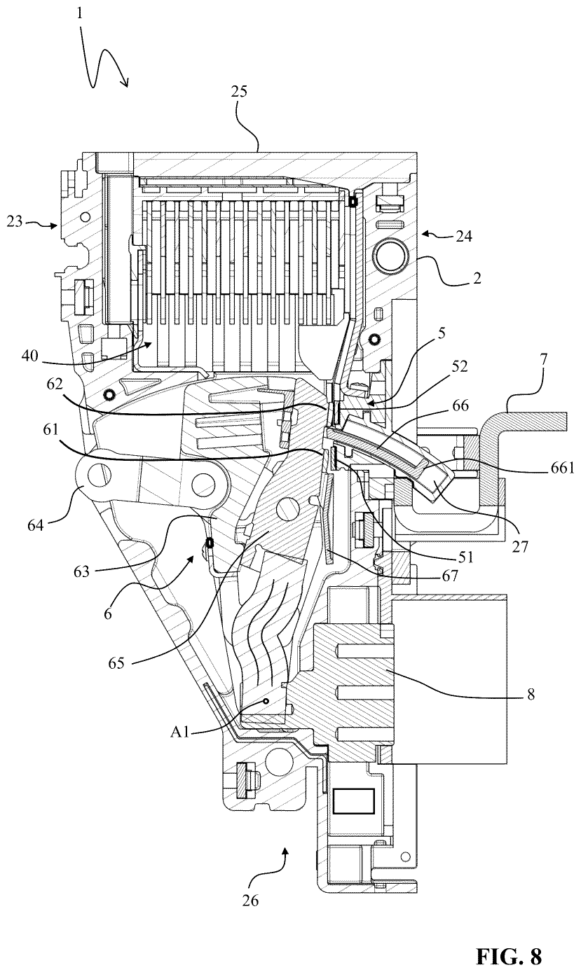

FIGS. 7-10 show the switch pole, according to an embodiment of the present disclosure. In FIGS. 8-10, the movable contact assembly 6 is shown in different operating positions during a maneuver of the switch pole.

In many respects, this embodiment of the present disclosure is similar to the embodiment of FIGS. 2-6. In this case, however, the insulating baffle 66 has a piston portion 661, which is always positioned in the receiving recess 27 and slidingly moves along this latter, when the movable contact assembly 6 moves about the rotation axis A1 during a maneuver of the switch pole.

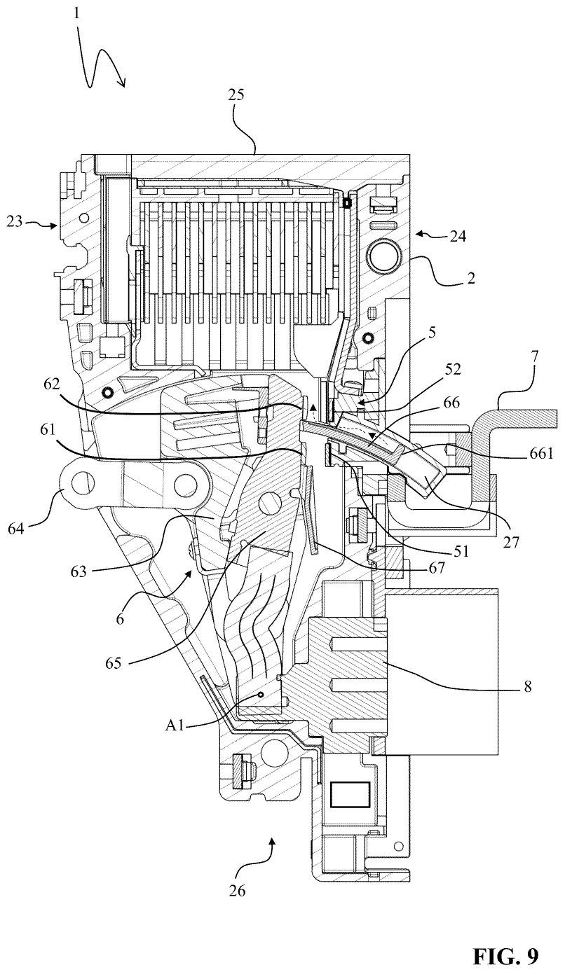

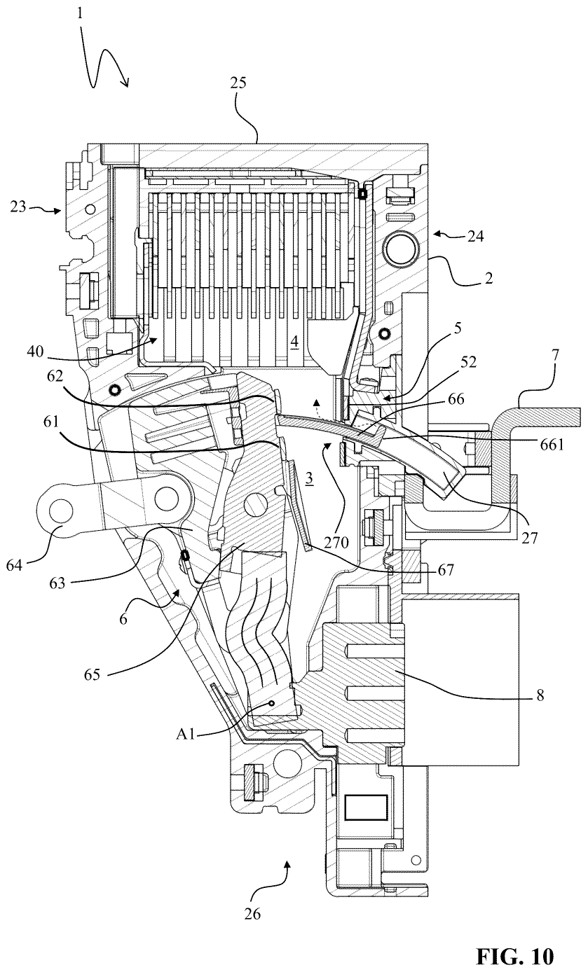

The piston portion 661 is arranged in such a way to cause a flux of pressurized air to blow towards the one or more second fixed contacts 52 of the fixed contact assembly and the one or more second movable contacts 62 of the movable contact assembly, during an opening maneuver of said switch pole (FIGS. 9-10, dotted lines).

The injection of pressurized air in the contact regions 3 at level of the arc contacts 52, 62 favors the flow of hot gases towards the arc-extinguishing region 4 and exerts a remarkable cooling action on the arc electric contacts of the switch pole.

In some embodiments, the insulating baffle 66 has a L-shaped free end 661 in an opposite position relative to the movable contacts 61, 62 of the movable contact assembly. Conveniently, such a shaped portion of the insulating baffle 66 forms the above-mentioned piston portion of the insulating buffer member.

In some embodiments, the transversal section of the receiving recess 27 is designed in such a way to be geometrically complementary and tightly match the shape of the piston portion 661. This helps to increase the pressure of the air blow towards the arc electric contacts 52, 62 of the switch pole.

In the embodiments shown in FIGS. 2-10, the insulated cover 67 of the movable contact assembly is fixed to the supporting structure 63 and it moves together with this latter.

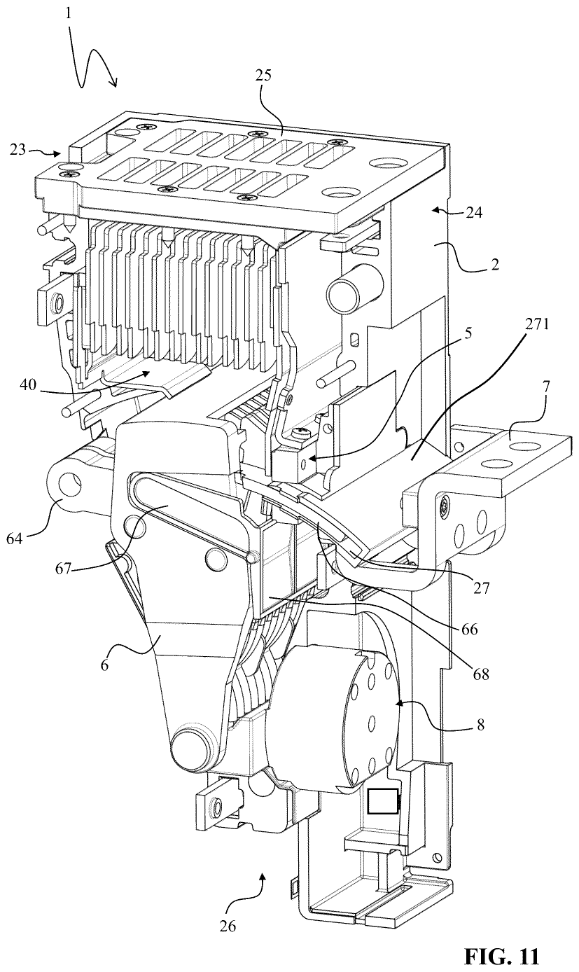

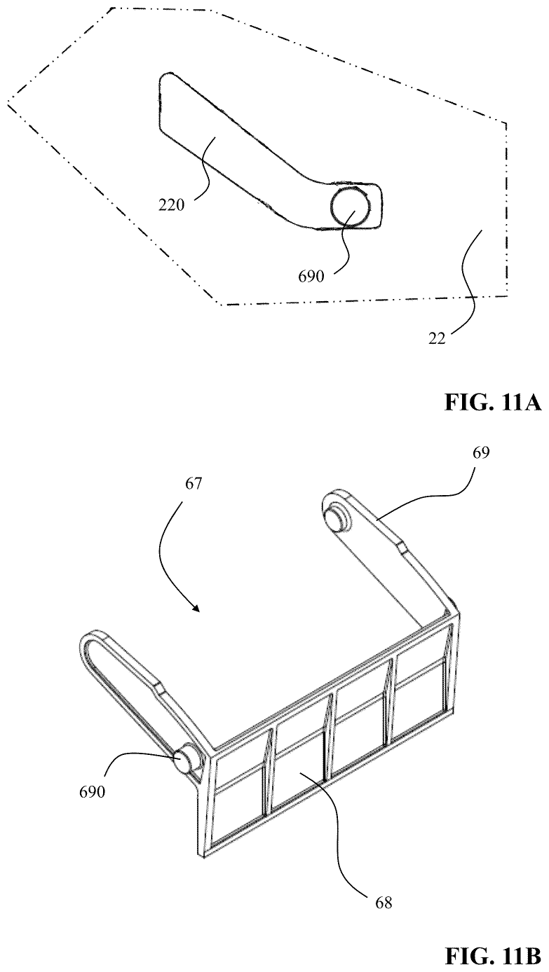

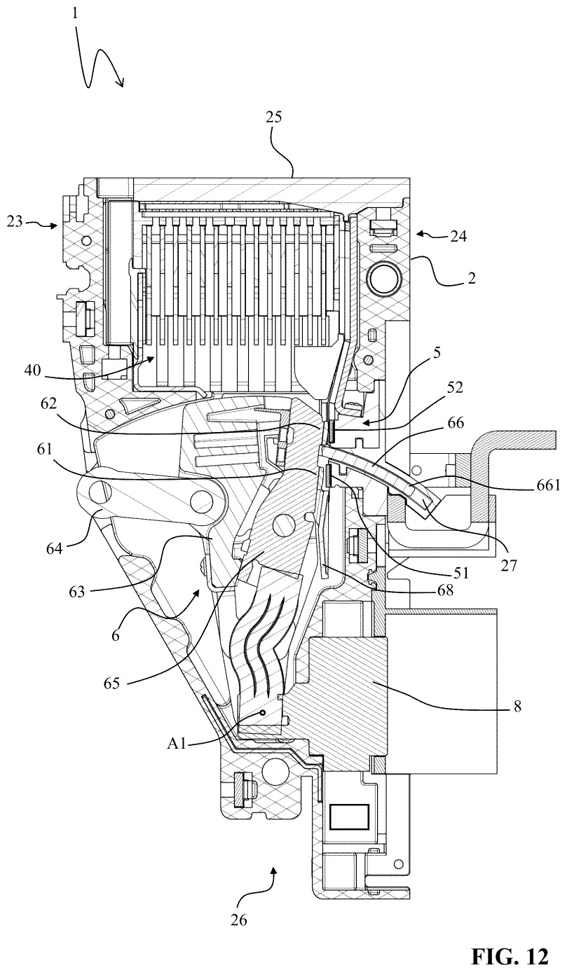

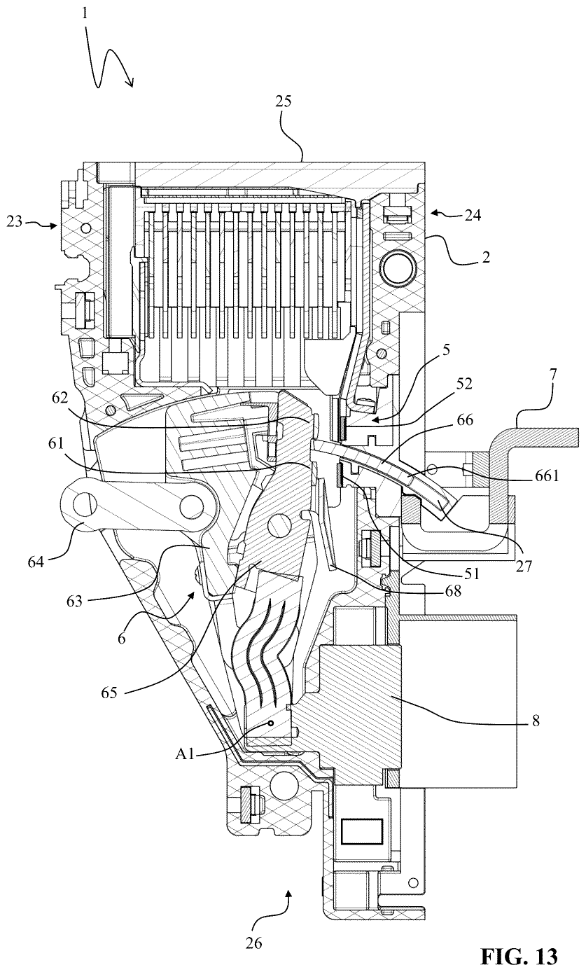

FIGS. 11, 11A-11B, 12-14 show the switch pole, according to another embodiment of the present disclosure. In FIGS. 12-14, the movable contact assembly 6 is shown in different operating positions during a maneuver of the switch pole.

In many respects, this embodiment of the present disclosure is similar to the embodiment of FIGS. 2-6. In this case, however, the insulated cover 67 is arranged in such a way to move together with the supporting structure about the rotation axis A1 and be also capable of moving relative to the supporting structure 63 during a maneuver of the switch pole.

The insulating cover 67 is hinged to the supporting structure 63 about a suitable hinging axis, which is conveniently parallel to the rotation axis A1 of the movable contact assembly.

The insulating cover 67 sometimes comprises lateral legs 69 hinged to the supporting structure 62 and arranged in such a way to cover portions of the conductive head 65 facing the lateral walls 22 of the insulated casing.

The above-mentioned lateral legs 69 have protrusions 670 slidingly inserted into corresponding grooves 220 of the lateral walls 22 of the switch pole (FIGS. 11A-11B).

During a maneuver of the switch pole, the movable contact assembly 6 moves and the lateral protrusions 670 of the insulating cover slide along the groves 220. The insulating cover 67 is thus forced move relative to the supporting structure 63 by rotating about its hinging axis.

According to other embodiments of the present disclosure, however, the insulating cover 67 may be arranged differently to move relative to the supporting structure 63 during a maneuver of the switch pole. For example, it may be arranged in such a way to move by inertia or upon actuation by suitable elastic means coupled to the insulating cover 67 and the supporting structure 63.

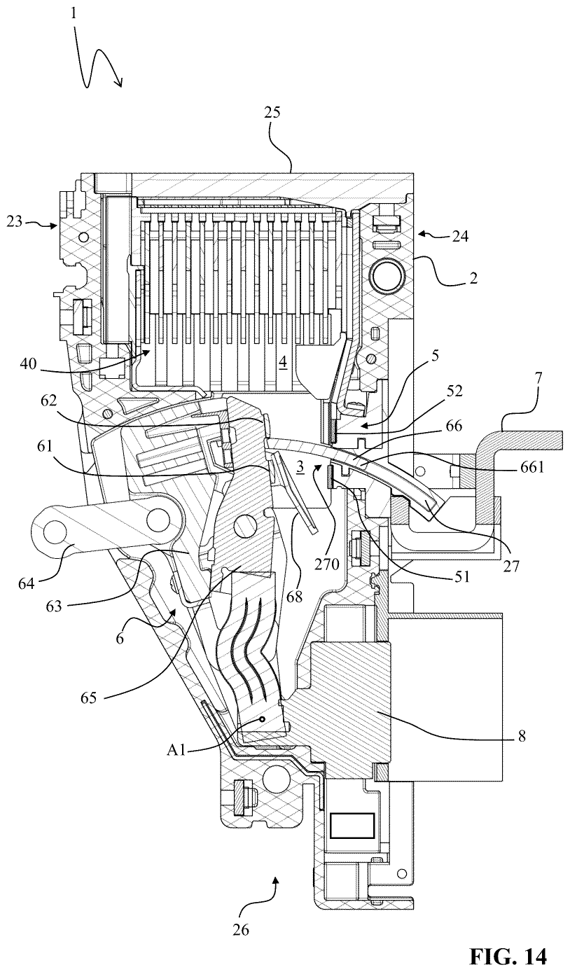

In general, the insulating cover 67 can move (relative to the supporting structure 63) between a first shield position (FIG. 12) and a second shield position (FIG. 14).

When it is in the first shield position, the insulated cover 67 has no portions interposed between the electric contacts of the switch pole.

When it is in the second shield position, the insulated cover 67 has a shield portion 68 interposed between the main electric contacts 51, 61 of the switch pole, namely, between the one or more first fixed contacts 51 of the fixed contact assembly and the one or more first movable contacts 61 of the movable contact assembly.

In some embodiments, when the insulating cover 67 is in the second shield position, the shield portion 68 covers the movable contacts 61 of the movable contact assembly, thereby segregating these electric contacts from the corresponding fixed contacts 51 of the fixed contact assembly.

The arrangement of the insulating cover 67 decreases the probability that electric arcs develop between the main electric contacts of the switch pole during an opening maneuver of the switch pole.

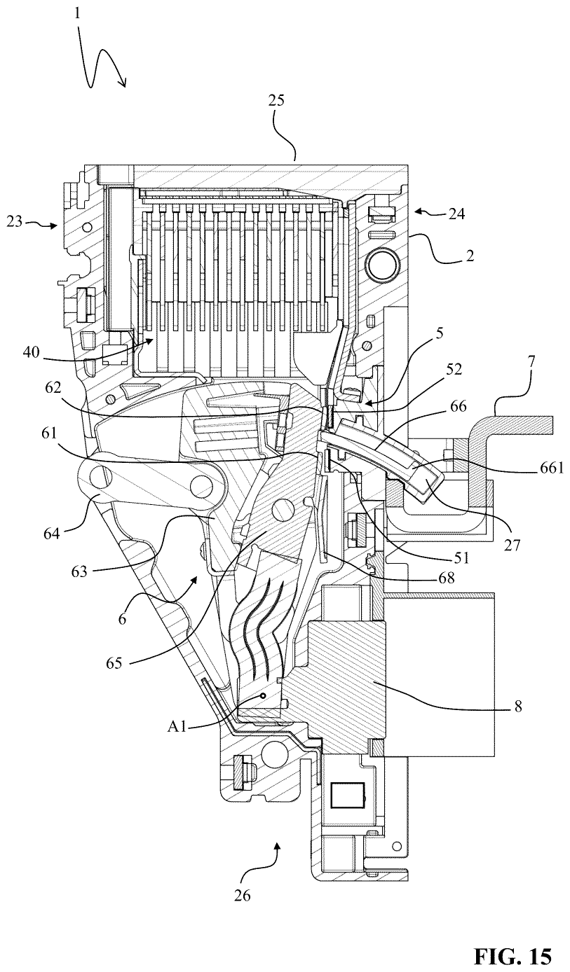

FIGS. 15-17 show the switch pole, according to another embodiment of the present disclosure, with the movable contact assembly 6 in different operating positions during a maneuver of the switch pole.

In many respects, this embodiment of the present disclosure is similar to the embodiment shown in FIGS. 8-10 described above. In this case, however, the movable contact assembly 6 includes a movable insulating cover 67 as explained above with reference to the embodiment of FIGS. 11, 11A-11B, 12-14.

The switch pole, according to the present disclosure, allows the proposed aims and the objects to be achieved.

The insulating baffle 66 of the movable contact assembly allows electric arcs arising between the electric contacts under separation to be efficiently confined in the arc extinguishing region of the switch pole, during an opening maneuver of the switching device.

This remarkably favors a uniform distribution of electric arcs along the arc chamber, which allows making more efficient their arc-quenching performances.

The arrangement of the insulating baffle 66 interposed between the main contacts and the arc contacts of the switch pole remarkably decreases the probability that electric arcs strike towards other conductive components of the switch pole, which are located outside the arc-extinguishing region 4.

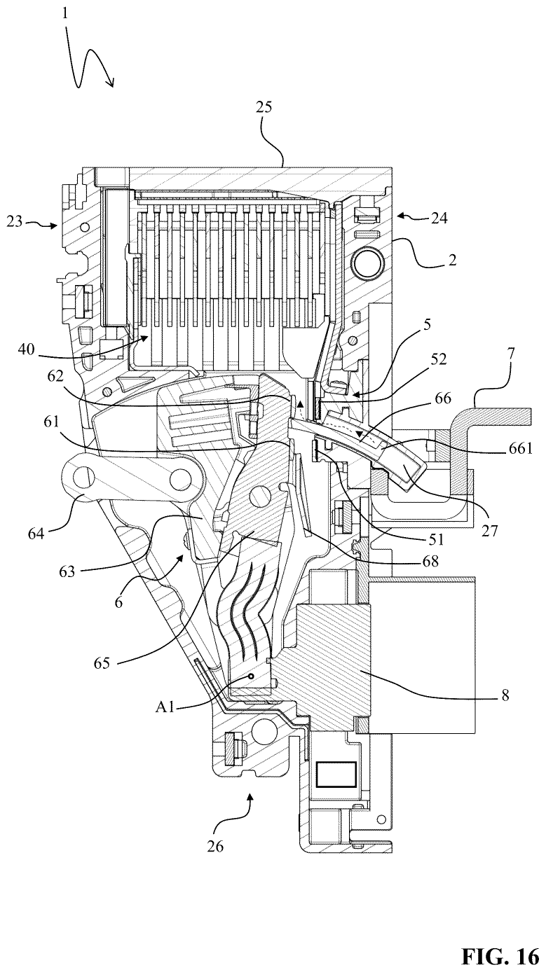

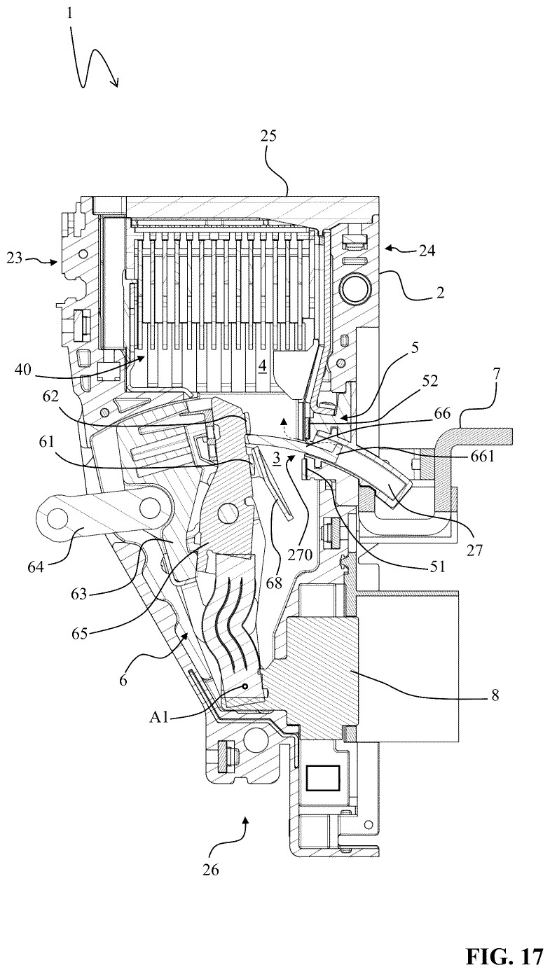

In some embodiments, the insulating baffle 66 causes a flow of pressurized air towards the arc contacts 52, 62 of the switch pole under separation during an opening maneuver of the switch pole. This solution allows further improving the segregation of electric arcs in the arc extinguishing region 4 of the switch pole (FIGS. 16-17, dotted lines).

In some embodiments, the movable contact assembly of the switch pole is provided with a movable insulating cover having a shield portion, which can interpose between the main electric contacts of the switch pole, during an opening maneuver of the switch pole.

This solution allows remarkably the probability that electric arcs develop between the main electric contacts of the switch pole, thus reducing erosion phenomena and prolonging the operating life of said electric contacts.

The switch pole of the present disclosure has a relatively simple and compact structure, which is relatively easy to manufacture at industrial level, at competitive costs compared to the currently available solutions on the market.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A switch pole for a switching device, the switch pole comprising:
an insulating casing that defines an internal space of the switch pole;
a first pole terminal and a second pole terminal configured to couple with corresponding line conductors of an electric line;
a fixed contact assembly including a plurality of fixed electric contacts electrically connected to the first pole terminal, the fixed electric contacts including one or more first fixed contacts and one or more second fixed contacts spaced apart and electrically insulated from the first fixed contacts; and
a movable contact assembly including a plurality of movable electric contacts electrically connected to the second pole terminal, the movable electric contacts including one or more first movable contacts and one or more second movable contacts, the movable contact assembly reversibly movable around a rotation axis so that the first movable contacts can be coupled to or decoupled from the first fixed contacts and the second movable contacts can be coupled to or decoupled from the second fixed contacts when the movable contact assembly moves about the rotation axis, during a maneuver of the switch pole,
wherein the movable contact assembly comprises an insulating baffle protruding towards the fixed contact assembly and slidingly inserted, at least partially, in a receiving recess defined by the insulating casing, the insulating baffle interposed between the one or more first fixed contacts and the one or more second fixed contacts of the fixed contact assembly and interposed between the one or more first movable contacts and the one or more second movable contacts of the movable contact assembly.

2. The switch pole according to claim 1, wherein the insulating baffle is positioned at a first spacing region between the one or more first movable contacts and the one or more second movable contacts of the movable contact assembly.

3. The switch pole according to claim 1, wherein the receiving recess has an aperture for a passage of the baffle, the aperture positioned at a second spacing region between the one or more first fixed contacts and the one or more second fixed contacts of the fixed contact assembly.

4. The switch pole according to claim 1, wherein the insulating baffle has a free end in an opposite position relative to the plurality of electric movable contacts of the movable contact assembly, the free end of the insulating baffle inserted in the receiving recess and configured to slidingly move along the receiving recess when the movable contact assembly moves about the rotation axis during the maneuver of the switch pole.

5. The switch pole according to claim 1, wherein the insulating baffle has a piston portion configured to slidingly move along the receiving recess when the movable contact assembly moves about the rotation axis during the maneuver of the switch pole, the piston portion configured to cause a flux of pressurized air to blow towards the one or more second fixed contacts of the fixed contact assembly and the one or more second movable contacts of the movable contact assembly during an opening maneuver of the switch pole.

6. The switch pole according to claim 5, wherein the insulating baffle has a free end in an opposite position relative to the plurality of electric movable contacts of the movable contact assembly, the free end of the insulating baffle inserted in the receiving recess and configured to slidingly move along the receiving recess when the movable contact assembly moves about the rotation axis during the maneuver of the switch pole, and wherein the piston portion is formed by the free end of the insulating baffle.

7. The switch pole according to claim 1, wherein the movable contact assembly comprises a supporting structure of the plurality of electric movable contacts of the movable contact assembly, the insulating baffle fixed to the supporting structure in such a way as to move together with the supporting structure when the movable contact assembly moves about the rotation axis during the maneuver of the switch pole.

8. The switch pole according to claim 7, wherein the movable contact assembly comprises an insulating cover at least partially covering one or more conductive portions of the movable contact assembly, the insulating cover mounted on the supporting structure in such a way as to move together with the supporting structure when the movable contact assembly moves about the rotation axis during the maneuver of the switch pole.

9. The switch pole according to claim 8 wherein the insulating cover is fixed to the supporting structure, the insulating baffle formed by a portion of the insulating cover.

10. The switch pole according to claim 8, wherein the insulating cover is hinged on the supporting structure and is configured to reversibly move relative to the supporting structure when the movable contact assembly moves about the rotation axis during the maneuver of the switch pole.

11. The switch pole according to claim 10, wherein the insulating cover is configured to move reversibly between a first shield position, at which the insulating cover has no portions interposed between the electric contacts of the switch pole, and a second shield position, at which the insulating cover has a shield portion interposed between the one or more first fixed contacts of the fixed contact assembly and the one or more first movable contacts of the movable contact assembly.

12. The switch pole according to claim 11, wherein the insulating cover is configured to move from the first shield position to the second shield position during an opening maneuver of the switch pole.

13. A low voltage switching device comprising:
a switch pole comprising:
an insulating casing that defines an internal space of the switch pole;
a first pole terminal and a second pole terminal configured to couple with corresponding line conductors of an electric line;
a fixed contact assembly including a plurality of fixed electric contacts electrically connected to the first pole terminal, the fixed electric contacts including one or more first fixed contacts and one or more second fixed contacts spaced apart and electrically insulated from the first fixed contacts; and
a movable contact assembly including a plurality of movable electric contacts electrically connected to the second pole terminal, the movable electric contacts including one or more first movable contacts and one or more second movable contacts, the movable contact assembly reversibly movable around a rotation axis so that the first movable contacts can be coupled to or decoupled from the first fixed contacts and the second movable contacts can be coupled to or decoupled from the second fixed contacts when the movable contact assembly moves about the rotation axis, during a maneuver of the switch pole,
wherein the movable contact assembly comprises an insulating baffle protruding towards the fixed contact assembly and slidingly inserted, at least partially, in a receiving recess defined by the insulating casing, the insulating baffle interposed between the one or more first fixed contacts and the one or more second fixed contacts of the fixed contact assembly and interposed between the one or more first movable contacts and the one or more second movable contacts of the movable contact assembly.

14. The low voltage switching device according to claim 13, wherein the insulating baffle is positioned at a first spacing region between the one or more first movable contacts and the one or more second movable contacts of the movable contact assembly.

15. The low voltage switching device according to claim 13, wherein the receiving recess has an aperture for a passage of the baffle, the aperture positioned at a second spacing region between the one or more first fixed contacts and the one or more second fixed contacts of the fixed contact assembly.

16. The low voltage switching device according to claim 13, wherein the insulating baffle has a free end in an opposite position relative to the plurality of electric movable contacts of the movable contact assembly, the free end of the insulating baffle inserted in the receiving recess and configured to slidingly move along the receiving recess when the movable contact assembly moves about the rotation axis during the maneuver of the switch pole.

17. The low voltage switching device according to claim 15, wherein the insulating baffle has a piston portion configured to slidingly move along the receiving recess when the movable contact assembly moves about the rotation axis during the maneuver of the switch pole, the piston portion configured to cause a flux of pressurized air to blow towards the one or more second fixed contacts of the fixed contact assembly and the one or more second movable contacts of the movable contact assembly during an opening maneuver of the switch pole.

18. The low voltage switching device according to claim 17, wherein the insulating baffle has a free end in an opposite position relative to the plurality of electric movable contacts of the movable contact assembly, the free end of the insulating baffle inserted in the receiving recess and configured to slidingly move along the receiving recess when the movable contact assembly moves about the rotation axis during the maneuver of the switch pole, and wherein the piston portion is formed by the free end of the insulating baffle.

19. The low voltage switching device according to claim 13, wherein the movable contact assembly comprises a supporting structure of the plurality of electric movable contacts of the movable contact assembly, the insulating baffle fixed to the supporting structure in such a way as to move together with the supporting structure when the movable contact assembly moves about the rotation axis during the maneuver of the switch pole.

20. The low voltage switching device according to claim 19, wherein the movable contact assembly comprises an insulating cover at least partially covering one or more conductive portions of the movable contact assembly, the insulating cover mounted on the supporting structure in such a way as to move together with the supporting structure when the movable contact assembly moves about the rotation axis during the maneuver of the switch pole.
